(19) United States
(12) Patent Application Publication
(10) Pub. No.: US 2006/0170820 A1
(43) Pub. Date: Aug. 3, 2006

(54) Synchronization methods and systems for audio frame decoder

(75) Inventor: Tsung-Yau Lin, Shalu Town (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Mediatek Incorporation

(21) Appl. No.: 11/048,127

(22) Filed: Feb. 1, 2005

(51) Int. Cl. H04N 7/08

(52) U.S. Cl. 348/473

(57) ABSTRACT

A synchronization method and system for decoding digital audio data stream. A data stream has synchronization words successively spaced with data payloads. A detector detects one of the synchronization words. A header sensor detects a frame header associated with a detected synchronization word. A location estimator estimates a search region in the data stream according to a detected header. If the search region is estimated, the word detector directly searches the search region to locate one of the synchronization words. A decision maker determines whether the system is synchronized with the data stream after the word detector locates one of the synchronization words.

### BACKGROUND

The present disclosure relates generally to synchronization methods and systems, and, more particularly, to synchronization methods and systems for decoding digital audio streams.

Various digital video/audio processing standards are widely used in the industry to encode video or audio data into digital encoded signals for further transmission or storage. For example, MPEG audio convention (ISO/IEC 11172-3 and ISO/IEC13818-3) compresses and decompresses audio signals at different sampling and bit rates. MPEG audio convention defines three layers: Layer I, Layer II, and Layer III. The digital encoded signals conforming to MPEG audio convention include a plurality of frames, each including a plurality of fields. FIG. 1 illustrates formats of three audio frames respectively specified in the three different layers of MPEG audio standard. Each audio frame of MPEG audio Layer I, for example, includes Header, Alloc, Scalefactors, Samples and ANC fields. Though MPEG audio layers I, II, and III have different formats, they have the same frame header format, shown in FIG. 2.

In the header of each audio frame, a synchronization word (syncword) is included first. A syncword normally presents a simple and specific data pattern for easy identification of the beginning of a frame. Conforming to MPEG audio convention, the data pattern of a syncword is fixed as ‘1111 1111 1111’ in the binary system, or ‘0xFFF’ in the hexadecimal system. A conventional system can forward search the fixed data pattern (‘O×FFF’) after the header of a current frame to locate the syncword for a next frame. By calculating the difference in positions of the syncwords of the current and next frames, the length of the current frame can be obtained.

However, the fixed data pattern may be emulated in an audio data stream. These are known as false or invalid syncwords, and may occur anywhere in an audio data stream. A false syncword may cause a false frame length.

It is necessary to differentiate these invalid syncwords from true syncwords, which only appear at the beginning of an audio frame. If decoding of audio data is begun before proper synchronization, the result will be severely distorted audio playback.

### SUMMARY

Embodiments of the present invention provide a system for synchronizing a data processing unit to a data stream. The data stream has synchronization words successively spaced with data for processing. The system comprises a detector, a header sensor, a location estimator, and a decision maker. The detector detects one of the synchronization words. The header sensor senses a frame header with a detected synchronization word. The location estimator estimates a search region in the data stream according to a detected header. If the search region is estimated, the detector directly checks the search region for one of the synchronization words. The decision maker determines whether the system is synchronized with the data stream after the detector directly detects one of the synchronization words occurs in the search region.

Embodiments of the invention other provide a method for synchronizing processing of a data stream. The data stream has synchronization words successively spaced with data. A synchronization word is located, followed by detection of a data header. A search region is estimated accordingly. The search region is directly checked for one of the synchronization words, followed by determination of whether the data processing system is synchronized with the data stream.

### BRIEF DESCRIPTION OF THE DRAWINGS

The invention can be more fully understood by the subsequent detailed description and examples with references made to the accompanying drawings, wherein:

FIG. 1 illustrates formats of three audio frames respectively specified in the three different layers of MPEG audio standard;

FIG. 2 illustrates an audio frame header format for three MPEG layers;

FIGS. 3 and 4 are flowcharts of synchronization methods according to embodiments of the invention; and

FIGS. 5 and 6 illustrate audio decoding systems according to embodiments of the invention.

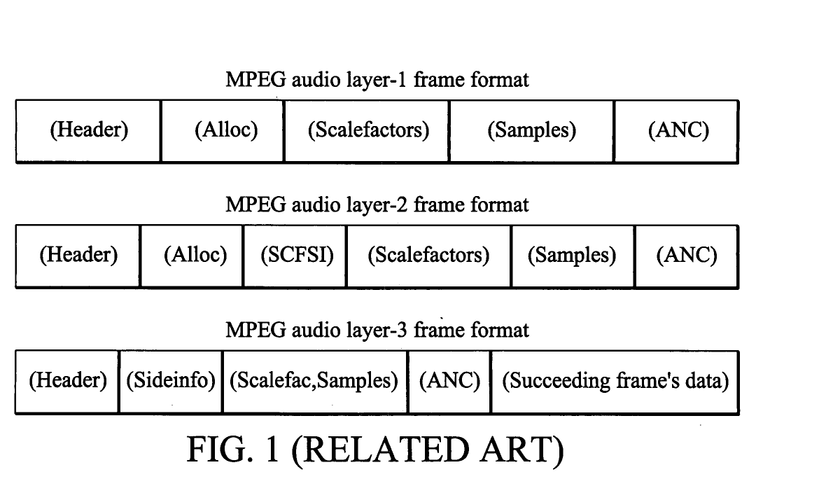

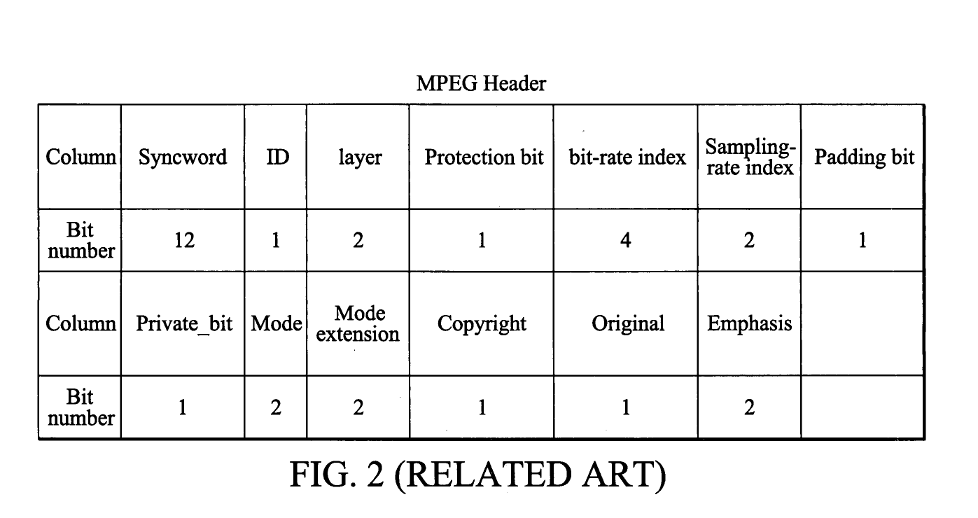

### DETAILED DESCRIPTION

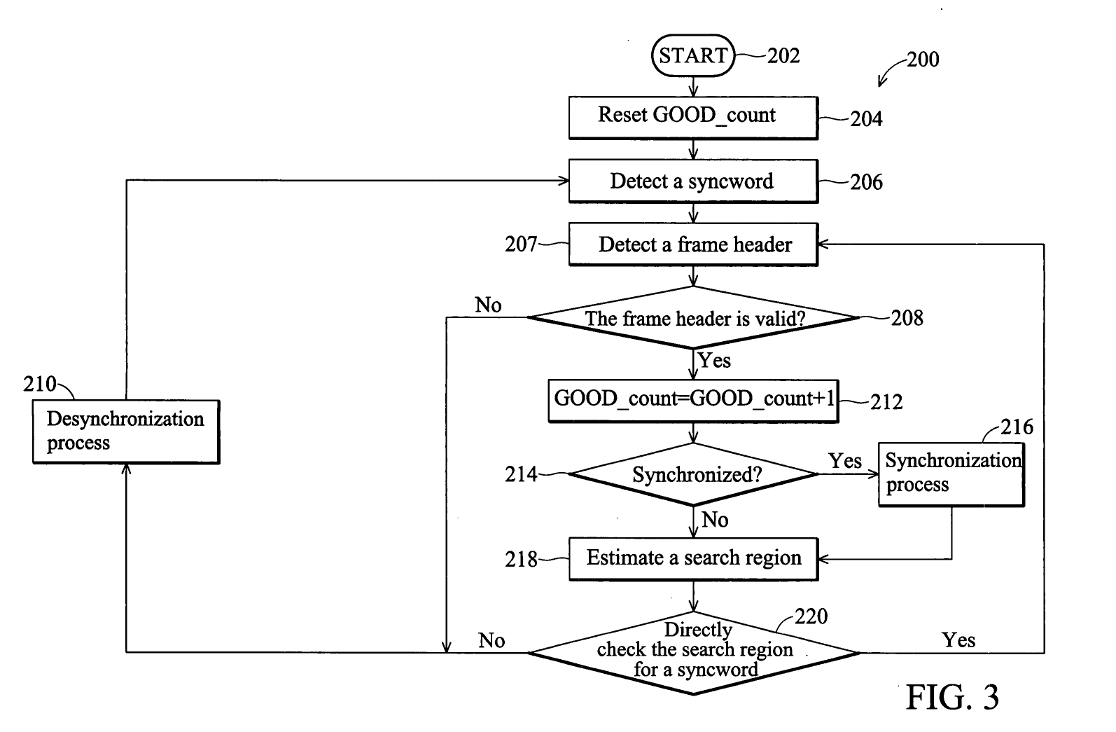

FIG. 3 is a flowchart of a synchronization method 200 according to embodiments of the invention. In step 204, an index, GOOD_count, is reset to 0. GOOD_count refers to the number of valid header(s).

Step 206 follows steps 204, wherein the first syncword in a received encoded audio data stream is detected. Since the audio data stream should comprise several frames, each having a frame header with a syncword, the first syncword is located. Conforming to MPEG audio convention, a frame header has a fixed length (32 bits) and starts with a syncword having twelve bits. In the audio data stream, pursuant to step 207, the data in the fixed length starting with the found syncword is thus detected as a frame header. Proceeding to step 208, it is determined whether the detected framed header is valid. Several columns in a frame header are defined in MPEG audio convention to exclude predetermined values, referred to as invalid values. For example, these invalid values can be in binary ‘00’ for the layer column, ‘1111’ for the bit rate index column, ‘11’ for the sampling rate index column, or ‘10’ for the emphasis column. Once the detected framed header has an invalid value, it is deemed invalid and the method 200 proceeds to step 210. Otherwise, the detected framed header is deemed valid and GOOD_count in step 212 is increased by 1.

In step 214, it is determined whether an audio decoding system using method 200 is synchronized with the audio data stream. The criteria for determination may be, for example, GOOD_count exceeding 3. If so, the audio decoding system provides synchronization in step 216, and the data in the audio can be properly decoded. If not, the audio decoding system remains unchanged.

Irrespective of the audio decoding system synchronization, step 218 follows, in which a search region is searched for a succeeding syncword. Only a valid frame header can estimate a search region correctly. To estimate a search region, formula with bit rate, sample rate and padding as variables, for example, can be employed. These variables can be determined in a valid frame header. With such variables, the length of a frame can be determined. The following exemplary formula for determining the interval between two successive syncwords is described in U.S. patent application Ser. No. 10/710,872, filed by the same inventor and assigned to the same party as the present invention, the contents of which are herein incorporated by reference. For layer I, the interval between two successive syncwords is expressed in bytes by
Frame length=(12×(bit rate/sampling rate)+padding)×4.

For layers II and III, the formula is expressed in bytes by
Frame length=144×(bit rate/sampling rate)+padding.

Frame length determines the end point of the current frame. The subsequent twelve bits, referred to as a search region, should be a syncword. Alternatively, a lookup table stored in a memory can be used, as disclosed in above-incorporated U.S. patent application. It should be appreciated to those skilled in the art that the way to determine the interval between two successive syncwords is not limited to the exemplary formula, and other suitable technologies are contemplated by the principles of the invention. Once the sampling rate and the bit rate of a frame header are retrieved, they can be applied to a pre-built lookup table as indices and starting and end positions can be extracted, thereby estimating a search region.

In step 220, it is determined whether a syncword actually occurs in the search region, ignoring the interval between the detected frame header and the search region. If so, the method returns to steps 207 and 208, and the validity of the frame header with the current found syncword is determined. If not, the method proceeds to step 210 comprising a de-synchronization process. For example, the decoding process or audio playback may be stopped and GOOD_count reset. The method then returns to step 206, where, starting after the search region, a subsequent syncword is sought. As mentioned previously, a negative answer in step 208 also brings the method to step 210.

If GOOD_count exceeds 1, at least one frame header is valid, whose syncword is found where successfully predicted by a preceding frame header. There is a trade-off between the level of assurance and the length of time for synchronization determination. The higher the number of GOOD_count required to claim synchronization, the more the assurance of the synchronization and the longer the time spent for determining the synchronization condition.

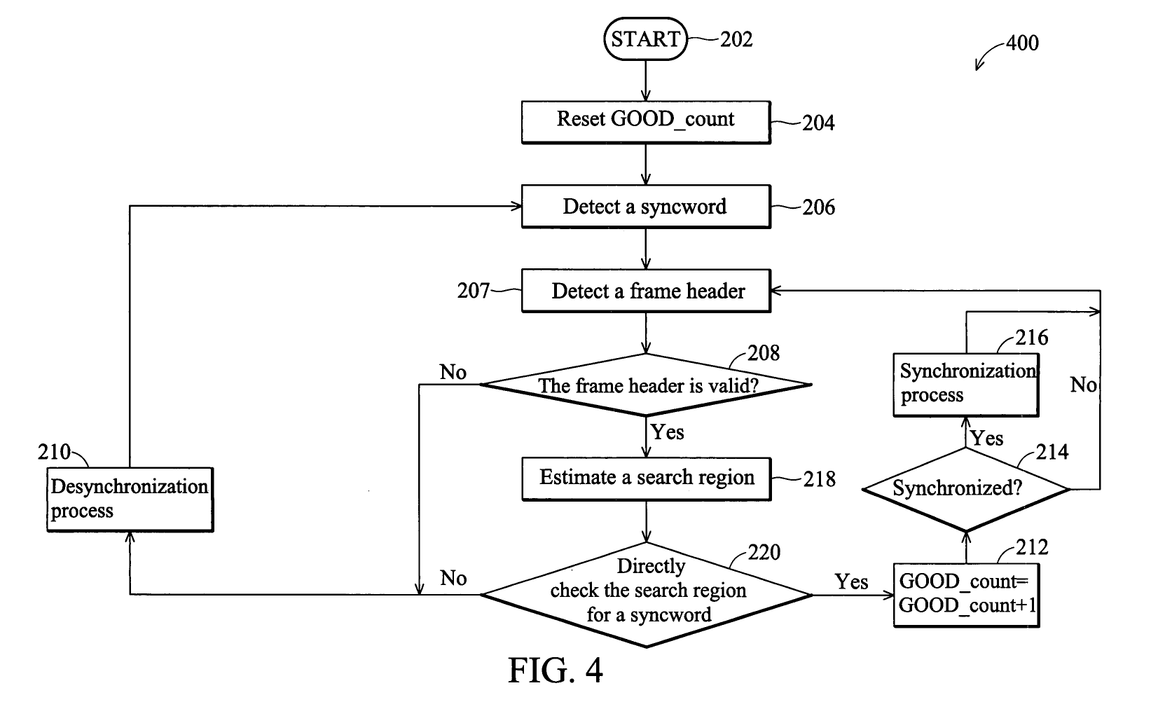

FIG. 4 is a flowchart of a synchronization method according to embodiments of the invention, wherein steps for varying GOOD_count and for determining synchronization or desynchronization are relocated. Unlike the method in FIG. 3, GOOD_count here refers to the number of good syncword(s). A syncword is defined as a good syncword if it is located in a search region, and GOOD_count increases by 1. Otherwise, it is a bad syncword. The flowchart in FIG. 4 should be self-explanatory for those skilled in the art after reading the disclosure in FIG. 3, and further detail is thus not required here.

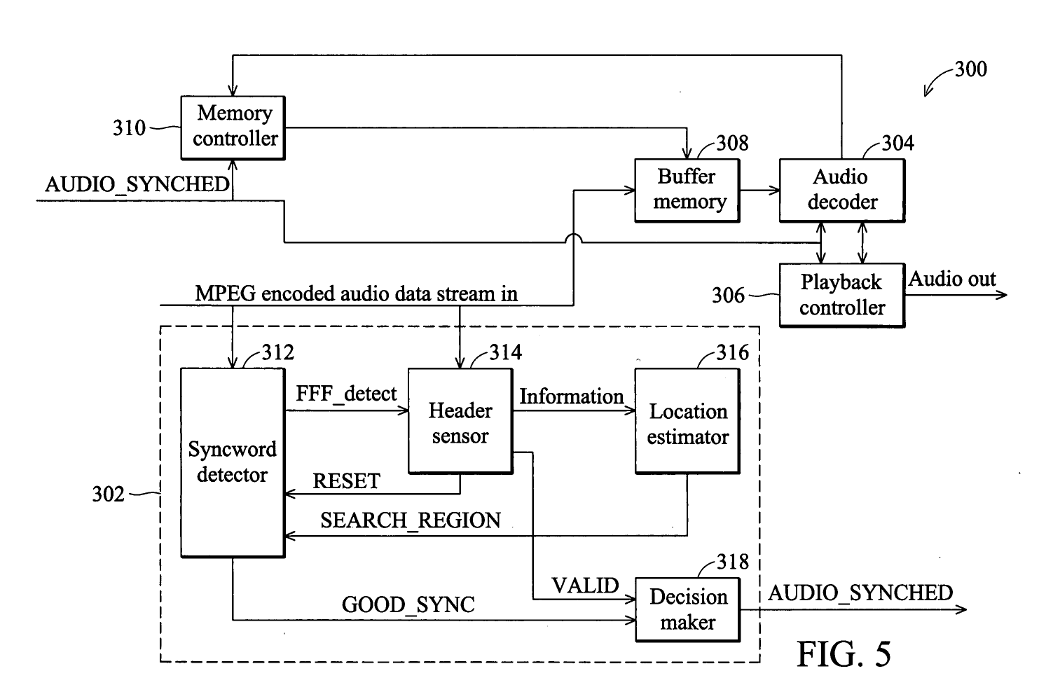

FIG. 5 illustrates an audio decoding system 300 according to embodiments of the invention, comprising a synchronizer 302 receiving MPEG encoded audio data stream input from the communication channel to synchronize the decoding of the audio frames using the method 200 as shown in FIG. 3.

The MPEG audio data stream is also applied to an audio decoder 304 which decodes audio data to generate decoded playback units applied to a playback controller 306.

The audio data, in audio frames, is stored in a buffer memory 308, controlled by memory controller 310 for reading or writing. The audio frames are read from buffer memory 308 and applied to audio decoder 304 for decoding and playback from the location of a read point controlled by audio decoder 304 as required by the decoding operation.

The synchronization system 302 generates an output signal “AUDIO_SYNCHED” having a logically high value when the synchronization system 302 is synchronized and a logically low value when the synchronization system is desynchronized. The signal is applied to memory controller 310, audio decoder 304 and/or playback controller 306. When the AUDIO_SYNCHED signal is high, the decoding operation proceeds in a normal manner. When it is low, audio decoder 304 performs audio syntax checking only.

Synchronizer 302 comprises a syncword detector 312, a header sensor 314, a location estimator 316 and a decision maker 318. If initialized, reset or receiving no search region from location estimator 316, syncword detector 312 detects the first syncword in the MPEG audio data stream and generates an FFF_detect pulse.

In response to the FFF_detect pulse, header sensor 314 extracts 20 bits following the sensed syncword to determine whether they constitute a valid frame header. If so, header sensor 314 extracts information such as bit rate, sampling rate and/or padding, applies them to location estimator 316, and asserts a signal VALID, which is applied to decision maker 318. If not, head sensor 314 applies a reset signal to syncword deterctor 312, directing syncword detector 312 to locate a subsequent syncword after the sensed frame header, and deasserts the signal VALID.

In response to the information from header sensor 314, location estimator 316 produces a signal SEARCH_REGION indicating a search region in the MPEG audio data stream where a subsequent syncword may occur. A formula or lookup table in location estimator 316 can generate the search region.

Upon receiving the SEARCH_REGION signal, syncword detector 312 ignores the interval between the detected frame header and the search region, and then directly checks the search region for a syncword. Successful location thereof generates assertion of not only signal FFF_detect but also signal GOOD_SYNC, applied to decision maker 318 to confirm the validity of a frame header.

Decision maker 318 accordingly checks the value of signals VALID and GOOD_SYNC and determines system synchronization if a predetermined condition is met, as exemplified in method 200. AUDIO_SYNCHED signal is maintained at or changed to logically low or high accordingly.

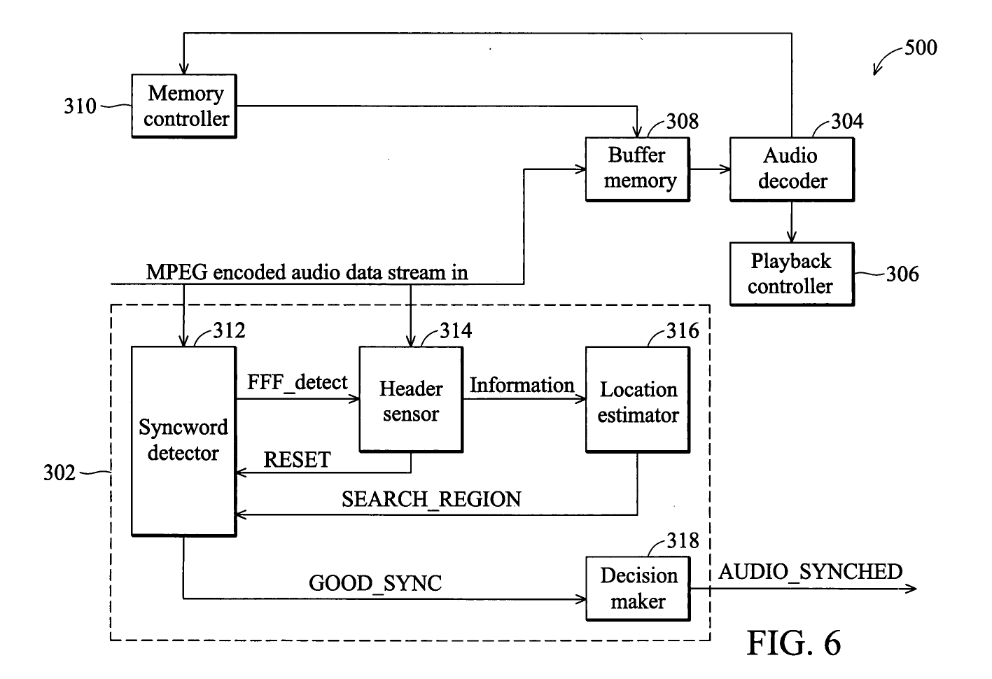

FIG. 6 illustrates an audio decoding system according to embodiments of the invention. In comparison with that in FIG. 5, the audio decoding system in FIG. 6 employs the method 400 shown in FIG. 4 and comprises a decision maker that determines the synchronization condition based on signal GOOD_SYNC only. The GOOD_SYNC is deasserted when an invalid frame header occurs or no syncword is found in a search region.

Embodiments of the invention directly check a search region for a syncword, rather than searching ahead after a frame header. Computation may, accordingly, be more efficient to promptly determine the synchronization of an audio decoding system.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A system for synchronizing a data processing unit in a data stream having synchronization words successively spaced with data, the system comprising:
a detector detecting one of the synchronization words;
a header sensor detecting a frame header comprising a detected synchronization word;
a location estimator estimating a search region in the data stream according to a detected header, wherein if the search region is estimated, the detector directly checks the search region for one of the synchronization words; and
a decision maker determining whether the system is synchronized to the data stream after one of the synchronization words is located in the search region.

2. The system as claimed in claim 1, wherein the data stream is an encoded audio data stream.

3. The system as claimed in claim 1, wherein if the detector does not locate a synchronization word in the search region, the detector proceeds to detect the first synchronization word succeeding the search region.

4. The system as claimed in claim 1, wherein the header sensor determines whether the detected header is valid.

5. The system as claimed in claim 4, wherein the location estimator estimates the search region when the detected header is valid.

6. The system as claimed in claim 4, wherein if the detected header is invalid, the detector proceeds to detect the first synchronization word succeeding the detected header.

7. The system as claimed in claim 1, wherein the decision maker deems the data processing system synchronized to the data stream based on a determined condition.

8. The system as claimed in claim 7, wherein the determined condition comprises a predetermined number of successive detected headers, each including a detected synchronization word, being deemed valid.

9. The method as claimed in claim 8, wherein the predetermined number exceeds one.

10. The method as claimed in claim 1, wherein the system further comprises an audio decoder decoding the data.

11. A method for synchronizing a data processing system to a data stream having synchronization words successively spaced with data, comprising.
detecting one of the synchronization words;
sensing a frame header with the detected synchronization word;
estimating a search region in the data stream according to a detected header;
directly checking in the search region for one of the synchronization words; and
determining whether the data processing system is synchronized to the data stream base after the search region is checked.

12. The method as claimed in claim 11, wherein after sensing, the method further comprises checking whether the detected header is valid.

13. The method as claimed in claim 11, wherein estimating is performed if the detected header is valid.

14. The method as claimed in claim 11, wherein determination comprises:
determining that the data processing system is synchronized to the data stream based on a determined condition

15. The method as claimed in claim 14, wherein the determined condition comprises a predetermined number of successive detected headers, each including a detected synchronization word, being deemed valid.

16. The method as claimed in claim 15, wherein the predetermined number exceeds one.

17. The method as claimed in claim 11, wherein the frame header includes bit and sampling rates estimating the search region.

18. The method as claimed in claim 17, wherein the search region is estimated based on a predetermined function with the bit and sampling rates as variables.

19. The method as claimed in claim 17, wherein the search region is estimated based on a lookup table with the bit and sampling rates as indices.

20. The method as claimed in claim 11, wherein the data stream is an encoded audio bit stream.
